(19) United States
(12) Patent Application Publication
(10) Pub. No.: US 2009/0051946 A1
(43) Pub. Date: Feb. 26, 2009

(54) IMAGE AREA SELECTING METHOD

(75) Inventor: Makoto Hibi, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/189,694

(22) Filed: Aug. 11, 2008

(30) Foreign Application Priority Data
Aug. 23, 2007 (JP) 2007-217382

(51) Int. Cl. H04N 1/56; G09G 5/00

(52) U.S. Cl. 358/1.9; 345/620

(57) ABSTRACT

A method for controlling a printing apparatus includes displaying a display image on a display unit based on image data, detecting a plurality of positions touched on a touch panel, for each of the positions detected on the touch panel, designating a position on the display image displayed on the display unit according to the position detected on the touch panel, obtaining an aspect ratio of a printing area, determining a crop area of the display image having the aspect ratio of the printing area and including all of the designated positions on the display image, and printing an image on a recording sheet based on the determined crop area.

### BACKGROUND OF THE INVENTION

1. Field of the Invention

The present invention relates to an image area selecting method useful for cropping an image that matches an aspect ratio of a printing area. More particularly, the present invention relates to a printing apparatus which is capable of carrying out the image area selecting method and printing the cropped image on a recording sheet.

2. Description of the Related Art

In recent years, a so-called digital camera which can record an image in various recording media including a CompactFlash memory as digital image data has become popular. Generally, a personal computer (PC) is used in printing an image taken by a digital camera with a printer.

FIG. 8 illustrates an example of a conventional printing system including a digital camera 101, a PC 102, and a printer 103. The digital camera 101 included in this printing system is connected to the PC 102 by a communication cable 104 such as an RS232C cable. The PC 102 is connected to the printer 103 by a communication cable 105 such as a Centronics cable or a Universal Serial Bus (USB) cable. An image taken by the digital camera 101 is transmitted to the PC 102 as digital image data through the communication cable 104 and converted into print data. Then, the print data is sent to the printer 103 through the communication cable 105. The printer 103 prints an image onto a recording sheet according to the print data.

Some users, however, do not have a PC which is necessary in the conventional printing system. Accordingly, printing methods which eliminate the need for a PC have been developed. One of such methods uses a card direct printing apparatus. In this apparatus, a memory card such as a CompactFlash memory card is loaded on the card direct printing apparatus and an image recorded in the memory card can be printed by the direct printing apparatus.

The card direct printing apparatus includes a display device used for confirming an image. An image in a memory card which is loaded on the card direct printing apparatus can be displayed on the display device. The display device is, for example, a liquid crystal panel. As is with a printing apparatus discussed in Japanese Patent Application Laid-Open No. 2006-005835, the user can select an image to be printed while viewing a screen of the display device.

Some of such printing apparatuses have a cropping function and are capable of printing an area cropped on the screen. A size or location of the cropping area on the screen can be changed using arrow keys and an enlarge/reduce button arranged on the operation panel. However, designating an arbitrary area with such arrow keys and enlarge/reduce button is complicated and difficult. Accordingly, a technique in which a user can change a cropping area with a touch panel has been proposed.

FIG. 9 illustrates an example of a cropping area on a display. As illustrated in FIG. 9, an image is displayed on a display screen and a cropping area 204 which is to be cropped is displayed so that the area can be recognized by the user.

When cropping the image displayed in the cropping area 204, the image is printed with an aspect ratio of the cropping area. Thus, if an aspect ratio of the printing area is set, the aspect ratio of the cropping area needs to be the same as that of the printing area. If, for example, borderless printing is performed, the aspect ratio of the cropping area will be the same as that of the recording sheet. Even if bordered printing is performed, the aspect ratio of the printing area needs to be the same as that of the cropping area if margins of the recording sheet are set. Thus, in FIG. 9, the cropping area 204 is displayed with a same aspect ratio as that of the printing area.

Further, the user can manipulate a cropping rectangle by touching the touch panel with a stylus. For example, the user can rotate the cropping area 204 90 degrees from the state illustrated in FIG. 9 by touching an on-screen rotate button 203. FIG. 11 illustrates the cropping area, which is rotated 90 degrees.

Further, the user can enlarge or reduce the cropping area 204 by dragging resizing handles 205 and 206 arranged on the upper left corner and the lower right corner of the cropping area 204 using the stylus. Furthermore, the user can move the location of the cropping area 204 on the screen by dragging an arbitrary point in the cropped rectangle.

FIG. 10 illustrates an example of enlarging the cropping area. The resizing handle 205 is dragged from a point 205 illustrated in FIG. 9 to point 205′ to enlarge the cropping area. Since the aspect ratio of the cropping area needs to be the same as that of the printing area even when the cropping area is enlarged, the aspect ratio of the cropping area 204 illustrated in FIG. 10 is the same as that of the cropping area 204 illustrated in FIG. 9. In enlarging or reducing the cropping area, the aspect ratio of the cropping area needs to be the same as that of the printing area. Thus, the resizing handles 205 and 206 can move only on a diagonal line that connects the resizing handles 205 and 206.

According to the above-described processing, the user needs to repeat procedures such as adjusting the size of the cropping area by dragging the resizing handle and moving and rotating the cropping area in setting a desired cropping area. Such operations are troublesome for the user. Furthermore, since a display screen and a touch panel included in the printing apparatus are relatively small, setting a cropping area on a display of the printing apparatus using the aforementioned method is extremely inconvenient for the user.

### SUMMARY OF THE INVENTION

The present invention is directed to a printing apparatus by which a user can easily set a desired cropping area.

According to an aspect of the present invention, the user can easily crop an image by simply designating on a display screen points to be printed.

According to an aspect of the present invention, a method for controlling a printing apparatus includes displaying a display image on the display unit based on image data; detecting a plurality of positions touched on the touch panel; for each of the positions detected on the touch panel, designating a position on the display image displayed on the display unit according to the position detected on the touch panel; obtaining an aspect ratio of a printing area; determining a crop area of the display image having the aspect ratio of the printing area and including all of the designated positions on the display image; and printing an image on a recording sheet based on the determined crop area.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a state of a touch panel where a user has arranged printing points which designate a cropping area by touching the touch panel according to an exemplary embodiment of the present invention.

FIG. 2 illustrates an example of forming the cropping area according to an exemplary embodiment of the present invention.

FIG. 3 illustrates an example of rotating processing of the cropping area according to an exemplary embodiment of the present invention.

FIGS. 4A and 4B illustrate the image illustrated in FIG. 1 with additional printing points.

FIG. 5 is a flowchart illustrating processing for determining a cropping area and printing an image with a printing apparatus according to an exemplary embodiment of the present invention.

FIG. 6 illustrates an example of a message displayed on the screen when the user selects a rotate button in a state where the cropping area cannot be rotated.

FIG. 7 illustrates a state where the cropping area is calculated based on the printing points designated by the user and the cropping area is displayed on the screen.

FIG. 8 illustrates an example of a conventional printing system.

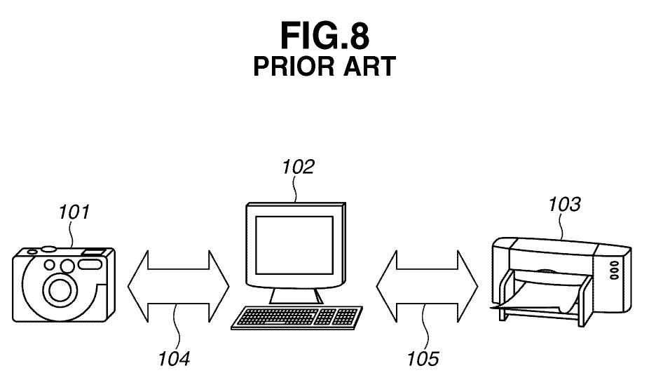

FIG. 9 illustrates an example of the cropping area.

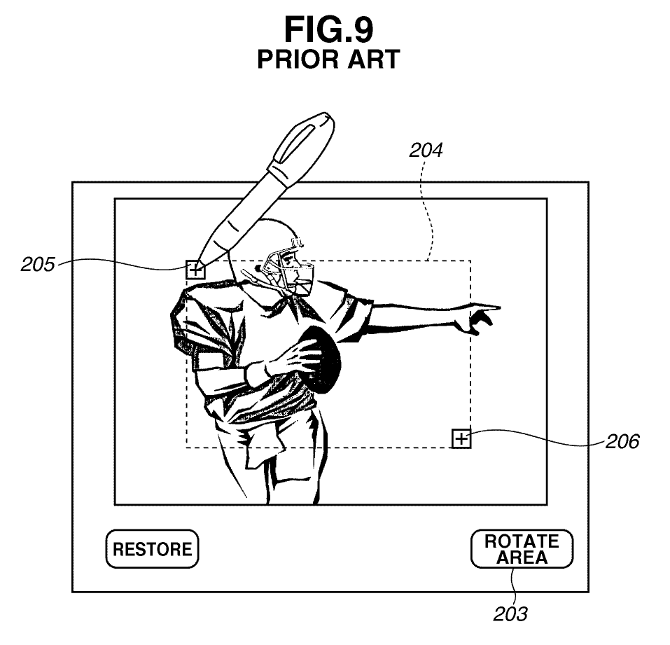

FIG. 10 illustrates an example of an enlarged cropping area.

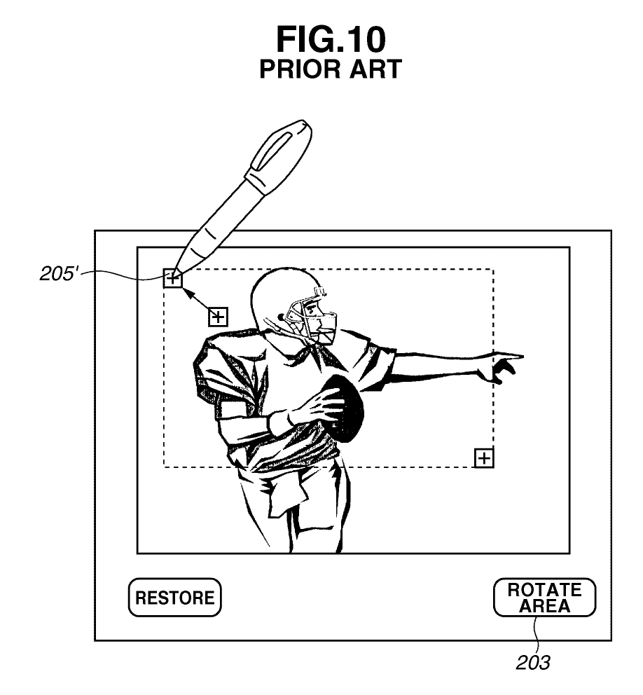

FIG. 11 illustrates an example of the cropping area rotated 90 degrees.

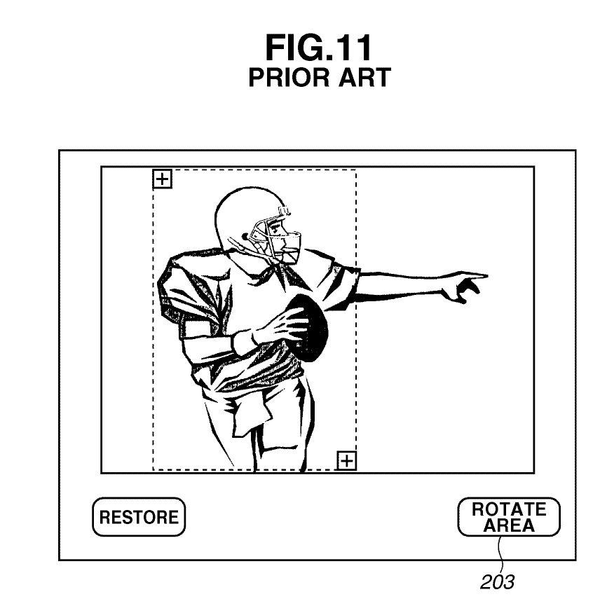

FIG. 12 is a block diagram illustrating a configuration of the printing apparatus according to an exemplary embodiment of the present invention.

FIG. 13 illustrates a rectangle having average coordinates of printing points designated by the user at the center of the rectangle according to an exemplary embodiment of the present invention.

### DETAILED DESCRIPTION OF THE EMBODIMENTS

Various exemplary embodiments, features, and aspects of the invention will be described in detail below with reference to the drawings.

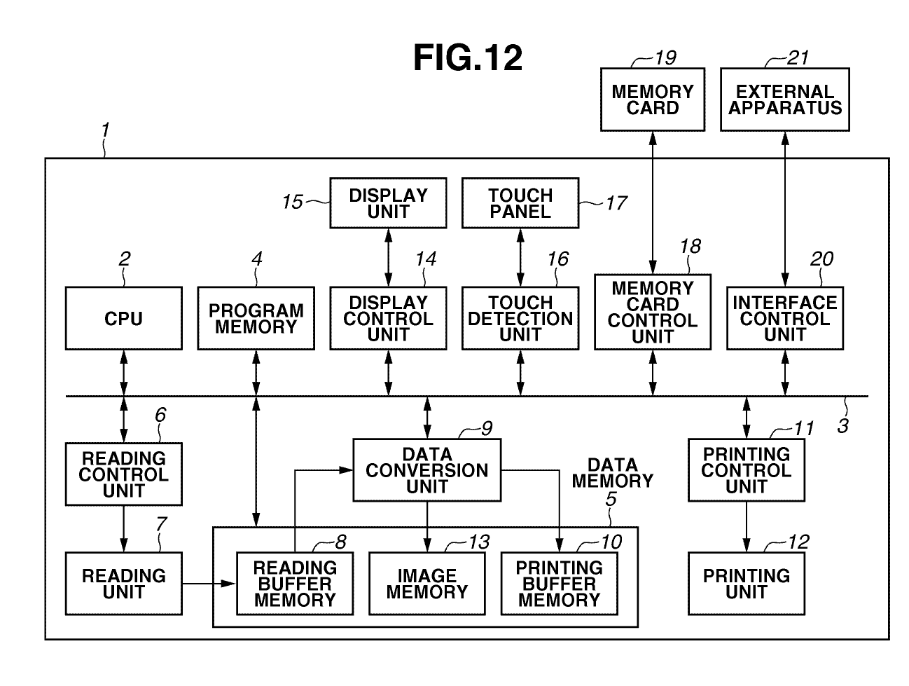

FIG. 12 is a block diagram illustrating a configuration of the printing apparatus 1 according to an exemplary embodiment of the present invention.

A central processing unit (CPU) 2, which is a microprocessor, operates based on a control program stored in a program memory 4 and content of a data memory 5 which is a random access memory (RAM). The CPU 2 is connected to the program memory 4 and the data memory 5 through an internal bus 3. Processing described below is realized by the CPU 2 executing a control program stored in the program memory 4.

The CPU 2 is a control unit which controls a printing apparatus 1. The CPU 2 operates a reading unit 7 to read a document through a reading control unit 6. The data which is read is stored in a reading buffer memory 8 in the data memory 5. In addition, the CPU 2 causes a display unit 15 to display an image through a display control unit 14 and operates a printing unit 12 through a printing control unit 11. Further, the CPU 2 performs various control according to a touch on a touch panel 17 detected by a touch detection unit 16.

The reading unit 7 reads a document set on a platen by an image sensor (not shown). The reading control unit 6 reads the document by controlling the reading unit 7 and inputs document image data to an image memory 13.

The image memory 13 is included in the data memory 5. Document image data input by the reading control unit 6 as well as various types of image data can be temporarily stored in the image memory 13. The CPU 2 performs various editing on the stored image data. A data conversion unit 9 converts the image data stored in the image memory 13 into print data and stores the print data in a printing buffer memory 10. The printing control unit 11 controls the printing unit 12 to print the print data stored in the printing buffer memory 10. The display control unit 14 controls the display unit 15 to display an image according to the image data stored in the image memory 13. The display unit is, for example, a light-emitting diode (LED) display or a liquid crystal display (LCD).

The touch panel 17 is provided on the front face of the display unit 15. The user can make various input operations while viewing the display unit 15. Thus, the user can enter various instructions following a display indicating where to touch or contents of control using the touch panel of the display unit 15.

The touch detection unit 16 detects whether the touch panel 17 is touched. If the touch detection unit 16 detects that the touch panel 17 is touched, then the touch detection unit 16 further detects the location of the touch. In other words, the touch detection unit 16 detects coordinate information of the touch on the touch panel. As described below, printing points of an image are designated via the touch panel. In the exemplary embodiments described below on-screen buttons designating desired operations are also implemented in the touch panel 17. It will be appreciated that other methods of user entry for designating the functions of the on-screen buttons can be used. The coordinate information is sent to the CPU 2, and the CPU 2 accordingly performs control based on the coordinate information. In this way, the user can issue desired instructions.

The user can use his finger or fingernail as well as an input member such as a stylus in touching the touch panel.

A memory card control unit 18 reads data stored in a memory card 19, which is a recording medium loaded on the printing apparatus 1, and writes data into the memory card 19. The CPU 2 controls the memory card control unit 18 to read image data recorded in the memory card 19, stores the image data in the image memory 13, and controls the printing unit 12 to print the image data or controls the display unit 15 to display the image data. Some of the image data stored, for example, in JPEG format has a thumbnail image in the header area. If the image data stored in the memory card 19 includes a thumbnail image, then the CPU 2 reads the thumbnail image and displays it on the display unit 15.

An interface control unit 20 controls communication through an interface and sends/receives data between the printing apparatus 1 and an external apparatus 21 which is connected to the printing apparatus 1. The external apparatus 21 is, for example, a personal computer (PC). The printing apparatus 1, which is connected to the PC, receives print data created by a printer driver running on the PC and prints the data. Further, an apparatus such as a digital camera can be connected to the printing apparatus 1. In this case, the printing apparatus 1 prints image data sent from the digital camera.

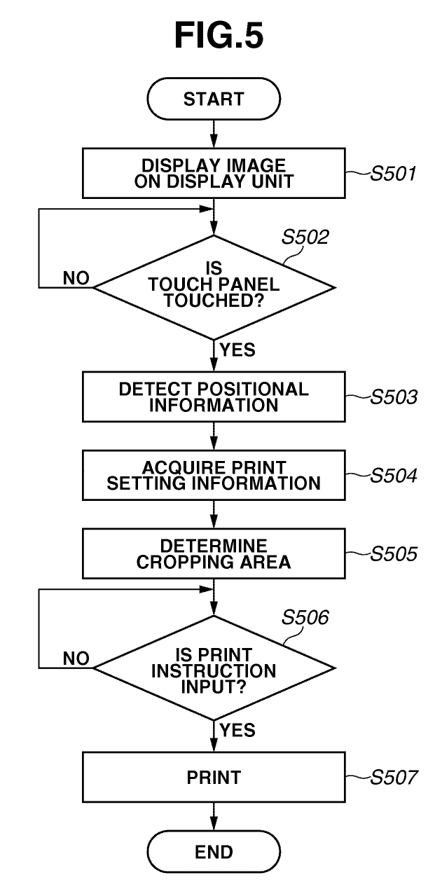

FIG. 5 is a flowchart illustrating processing for determining a cropping area and printing an image with the printing apparatus according to an exemplary embodiment of the present invention. The processing illustrated in FIG. 5 is executed by the CPU 2.

In step S501, the CPU 2 accesses the memory card 19 through the memory card control unit 18, reads the image stored in the memory card control unit 18, and displays the image on the display unit 15. In step S502, the CPU 2 determines whether the touch detection unit 16 has detected an input on the touch panel. If the CPU 2 determines that the touch detection unit 16 has detected the touch (YES in step S502), then the process proceeds to step S503. In step S503, the CPU 2 detects coordinate information of the touch.

In step S504, the CPU 2 acquires print setting information about the printing area. For example, the CPU 2 acquires print setting information including whether borderless printing is to be performed. If borderless printing is to be performed, the aspect ratio of the printing area will be the same as that of the recording sheet. In this case, the CPU 2 acquires the aspect ratio of the printing area from the print setting information about the recording sheet to be printed. If borderless printing is not to be performed, the CPU 2 can still acquire the printing area based on a type of the recording sheet and a margin of the sheet.

Next, in step S505, the CPU 2 determines a cropping area based on the coordinate information detected in step S502 and the print setting information about the printing area acquired in step S504. Details of this processing will be described below.

In step S506, the CPU 2 determines whether the user has input a print instruction. If the CPU 2 determines that the user has input a print instruction (YES in step S506), then the CPU 2 crops the image of the cropping area determined in step S505 from the image acquired in step S501 and instructs the printing unit 12 to print the cropped image through the printing control unit 11.

If the image displayed in step S501 is a thumbnail image, then in step S506, the CPU 2 crops the area that corresponds to the cropping area determined in step S505 from the image stored in the memory card.

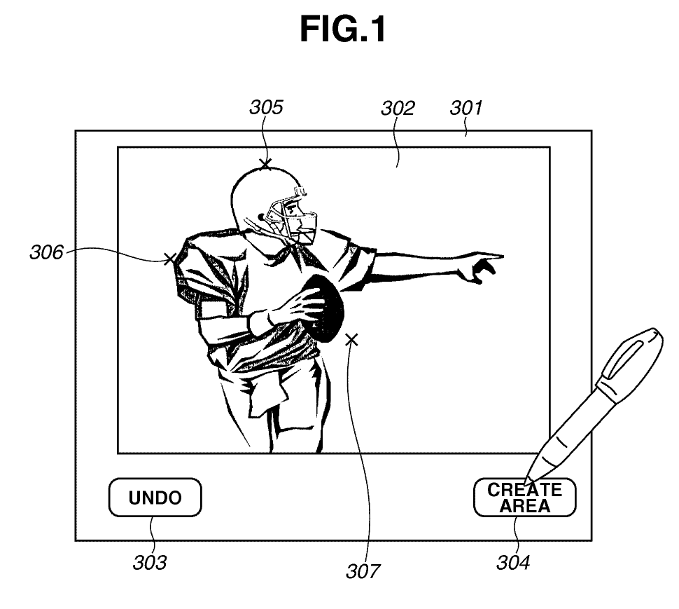

FIG. 1 illustrates an image in a state where printing points which the user inputs by touching the touch panel to designate the cropping area are designated on the screen. In FIG. 1, the printing apparatus is already in a cropping mode used for setting the cropping area. Three printing points 305 through 307 are set according to the points touched by the user and detected according to the process in step S503 in FIG. 5. The printing points are the points that the user wishes to include in the cropping area. In other words, the printing points are the points in the image that the user wishes to print without fail.

An area 301 is an area including the display unit 15 and the touch panel 17. The area 301 is an area where the image can be displayed as well as where an input by a stylus is possible. An image area 302 is an area where the image is displayed on the touch panel and digital image data read out from the memory card 19 is displayed. When on-screen buttons 303 and 304 are touched by the user, a corresponding control is performed. For example, if the user touches the on-screen “undo” button 303, the last printing point (in this case, the point 307) that the user has entered can be deleted.

Further, if the user touches the on-screen “create area” button 304, a cropping area which includes the printing points 305 through 307 and whose aspect ratio is the same as that of the printing area which is already set is automatically created.

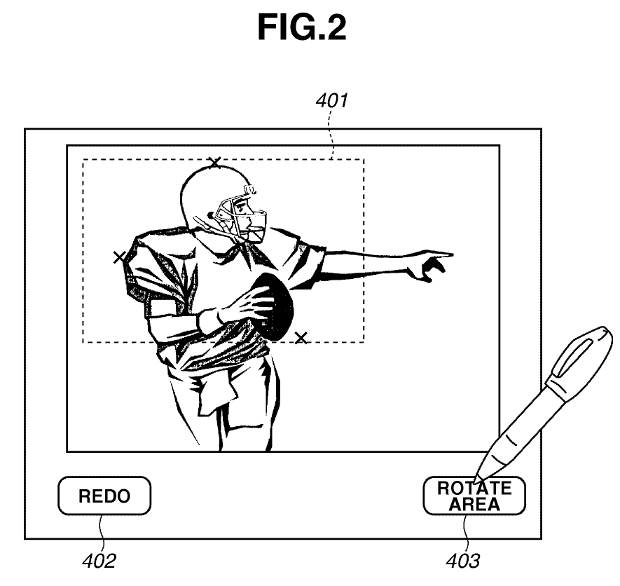

FIG. 2 illustrates an example of creating the cropping area according to the present exemplary embodiment. If the user inputs a plurality of arbitrary points using the touch panel and then touches the on-screen “create area” button 304 in the state illustrated in FIG. 1, the cropping area 401 is automatically created. If the image is in a state illustrated in FIG. 2, an on-screen “redo” button 402 and an on-screen “rotate area” button 403 are displayed in place of the on-screen “undo” button 303 and the on-screen “create area” button 304.

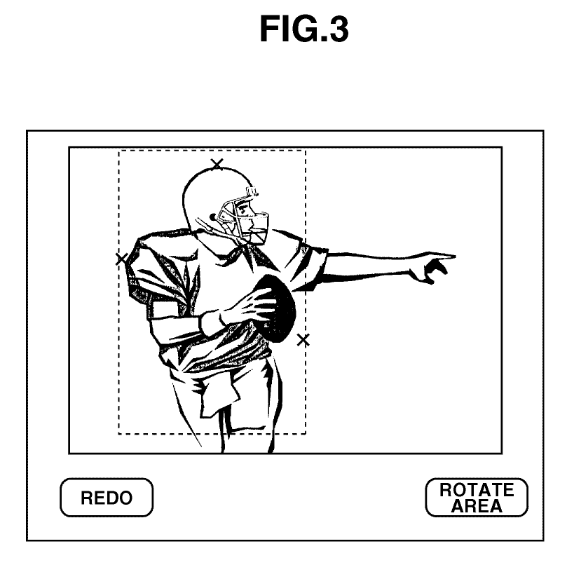

FIG. 3 illustrates an example of rotating processing of the cropping area according to the present exemplary embodiment. If the user touches the on-screen “rotate area” button 403 in the state illustrated in FIG. 2, the cropping area is rotated 90 degrees and will be in a state illustrated in FIG. 3. Even in this case, the printing points designated by the user remain unchanged and the cropping area including the printing points will be in a portrait orientation.

The user may, however, not be satisfied with the state illustrated in FIG. 2. That is a case where the user finds out an area which he does not want to miss besides the three points that he has designated, after viewing the actual cropping area. In this case, by touching the on-screen button 402, the user can return to the state illustrated in FIG. 1. Then, the user can add additional printing points.

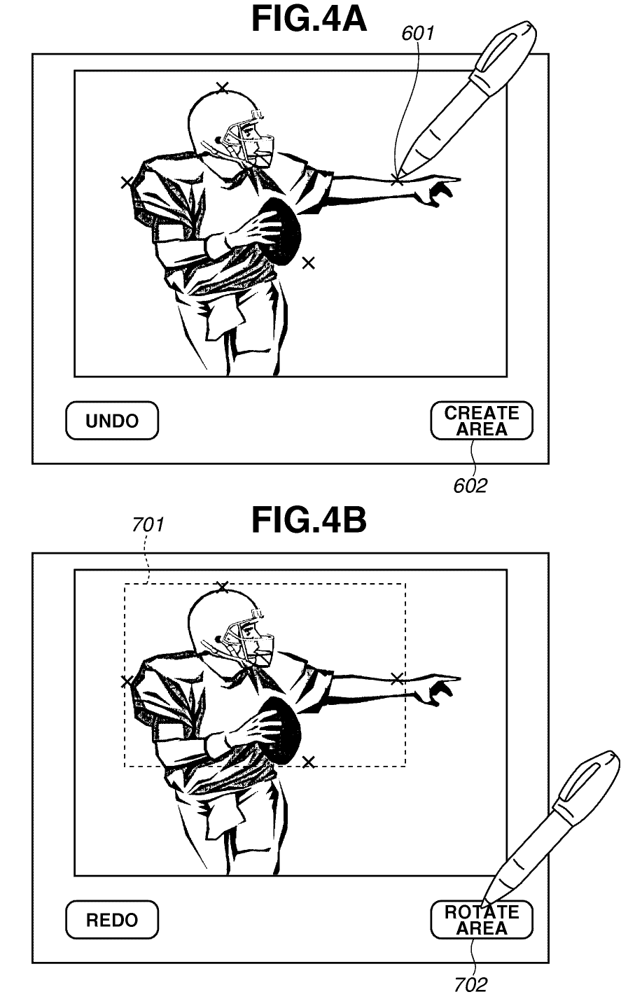

FIGS. 4A and 4B illustrate the image illustrated in FIG. 1 with an additional printing point. FIG. 4A illustrates a state where a printing point 601 is added. If an on-screen “create area” button 602 is touched in a state where the four printing points are designated, then a new cropping area 701 can be created as illustrated in FIG. 4B.

If an on-screen “rotate area” button 702 is touched in a state illustrated in FIG. 4B, the cropping area will be rotated 90 degrees as described above. However, depending on a location of the printing point that the user has designated, the cropping area may run off the edge of the image area when the cropping area is rotated. In this case, the cropping area cannot be rotated.

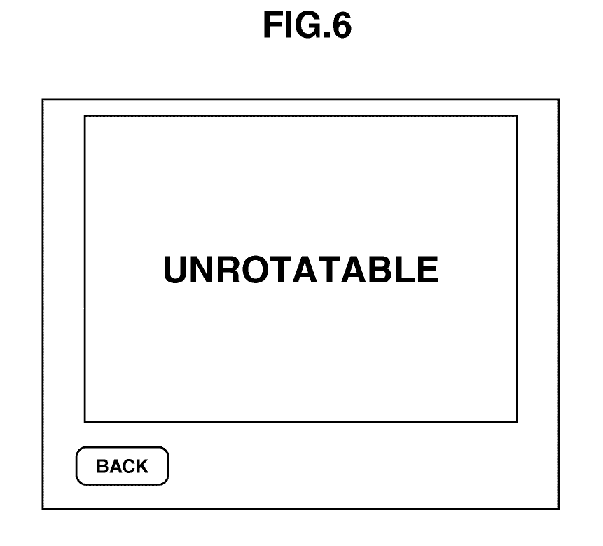

FIG. 6 illustrates an example of a message displayed when the user has selected a rotate button in a state where the cropping area cannot be rotated. In this case, as illustrated in FIG. 6, a message is displayed on the display area to inform the user that the cropping area cannot be rotated 90 degrees.

Next, a method for calculating the cropping area based on the printing points designated by the user will be described in detail.

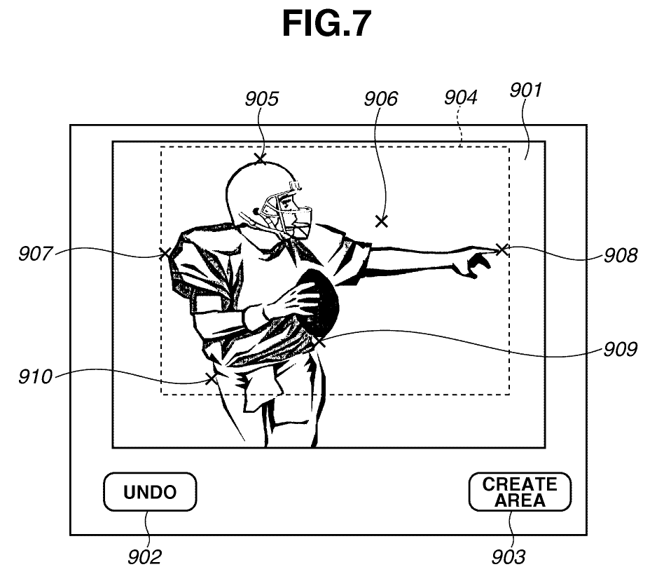

FIG. 7 illustrates an image area 901 in a state where the cropping area is calculated based on the printing points 905-910 designated by the user and the cropping area 904 is displayed on the screen. The user can remove the last designated printing point using an on-screen “undo” button 902. In calculating the cropping area upon selection of an on-screen “create area” button 903, the CPU 2 detects a maximum value and a minimum value of each of XY coordinates from a plurality of printing points designated by the user and calculates a “user-designated minimum rectangle” (not shown).

At this time, the horizontal direction is defined as the X coordinate, the vertical direction is defined as the Y coordinate, and the upper left corner is defined as an origin point of the XY coordinates. In the cropping area illustrated in FIG. 7, a printing point 907 has a minimum X coordinate value Xmin and a printing point 908 has a maximum X coordinate value Xmax. Further, a printing point 905 has a minimum Y coordinate value Ymin and a printing point 910 has a maximum Y coordinate value Ymax. The “user-designated minimum rectangle” (not shown) is an area where coordinates on the upper left corner are (Xmin, Ymin) and coordinates on the lower right corner are (Xmax, Ymax).

Next, the user-designated minimum rectangle is transformed into a rectangle having the aspect ratio of the printing area to calculate a cropping area. For example, if the aspect ratio of the printing area designated by the user for printing is 10:8, then, according to the present exemplary embodiment, an upper left corner (x1, y1) and a lower right corner (x2, y2) of a cropping area 904 will be calculated based on the previously calculated “user-designated minimum rectangle” as described below.

First, the CPU 2 determines whether the “user-designated minimum rectangle”, which includes all the designated printing points as described above, is in landscape orientation or portrait orientation with respect to the aspect ratio of the printing area. The CPU 2 determines the orientation by calculating and comparing (Xmax−Xmin)/(Ymax−Ymin) to 10/8. If (Xmax−Xmin)/(Ymax−Ymin) is greater than 10/8, then the “user-designated minimum rectangle” is determined to be in landscape orientation. Next, the height of the user-designated minimum rectangle is extended while the width of the user-designated minimum rectangle is maintained so that the aspect ratio of the rectangle is the same as that of the printing area.

In this case, the width of the rectangle can be obtained from the Xmax and the Xmin of the printing points which the user designated. Thus, by obtaining x1, x2, y1, and y2 which satisfy the following equations (1) through (4), a cropping area including the designated printing points and having an aspect ratio same as that of the printing area can be obtained.

x1=Xmin (1)

x2=Xmax (2)

(x2−x1):(y2−y1)=10:8 (3)

Ymin−y1=y2−Ymax (4)

According to the present exemplary embodiment, if the user-designated minimum rectangle is in landscape orientation, the cropping area is calculated so that a distance between Ymin and y1 equals a distance between Ymax and y2 as expressed in the equation (4). The cropping area can be calculated in a similar manner when the user-designated minimum rectangle is in portrait orientation.

According to the present exemplary embodiment, if the coordinate y1 after the calculation is negative, then the coordinate y1 is computationally off an image area 901. Thus, if a negative y1 is obtained, then y1 is taken as zero so that the cropping area fits in the image area 901. For that purpose, both y1 and y2 are corrected by adding a reverse value of y1 to y1 and y2. For example, if y1=−3 and y2=50, then 3 is added to both y1 and y2.

Similarly, if y2 exceeds the maximum value of the image area, then a difference between y2 and the maximum value is subtracted from both y1 and y2. For example, if the maximum value of the image area is 100 and y2 is 110, then 10 is subtracted from y2 to obtain 100 and 10 is also subtracted from y1. In this way, the cropping area is corrected to fit in the image area.

If a negative x1 is obtained or if x2 exceeds the maximum display area, then a similar correction will be made to the cropping area in the x direction.

According to the first exemplary embodiment, the cropping area is set based on a minimum rectangle including all of the user-designated printing points (i.e., the user-designated minimum rectangle). According to the present exemplary embodiment, average coordinates of each of the user-designated printing points are obtained and the cropping area is set with the average coordinates arranged at the center of the cropping area.

First, a rectangle including all the printing points and having the average coordinates set at the center is obtained. If the coordinates of the printing points designated by the user are (X1, Y1), (X2, Y2) . . . (Xn, Yn) (n is an integer), then the average coordinates (Xavr, Yavr) will be as follows:

Xavr=X1+X2+ . . . +Xn/n (5)

Yavr=Y1+Y2+ . . . +Yn/n (6)

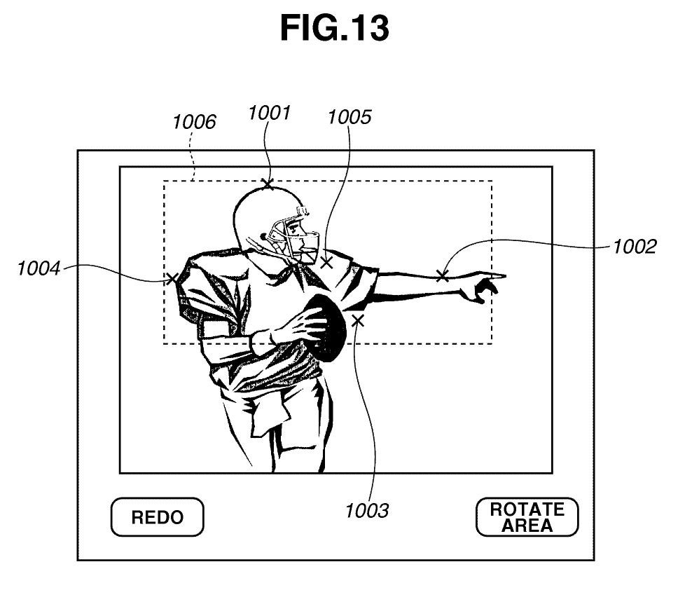

FIG. 13 illustrates a rectangle having average coordinates of printing points designated by the user set at the center. Since printing points 1001 through 1004 are printing points designated by the user, average coordinates 1005 (Xavr, Yavr) are obtained from the equations (5) and (6) where a number n is 4.

Next, (Xavr−Xmin) and (Xmax−Xavr) and also (Yavr−Ymin) and (Ymax−Yavr) are compared respectively. In FIG. 13, Xmin is the X coordinate of the printing point 1004, Xmax is the X coordinate of the printing point 1002, Ymin is the Y coordinate of the printing point 1001, and Ymax is the Y coordinate of the printing point 1003.

Then, in FIG. 13, for example, (Xavr−Xmin) is greater than (Xmax−Xavr) and (Yavr−Ymin) is greater than (Ymax−Yavr). In this case, in setting the central coordinate at the center of the rectangle, Xmax′ and Ymax′ that satisfy the following equation will be obtained.

(Xavr−Xmin)=(Xmax′−Xavr) (7)

(Yavr−Ymin)=(Ymax′−Yavr) (8)

In this way, a rectangle 1006 having (Xmin, Ymin) at the upper left corner and (Xmax′, Ymax′) at the lower right corner is obtained. Similar to the first exemplary embodiment, by adjusting the aspect ratio of the rectangle 1006 to that of the printing area, a cropping area having the average coordinates of the printing points at the center can be set. Further, even if a comparison result of (Xavr−Xmin) and (Xmax−Xavr) or (Yavr−Ymin) and (Ymax−Yavr) is different from what is illustrated in FIG. 13, a rectangle having average coordinates set at the center can be obtained in a similar manner.

As is with the first exemplary embodiment, the cropping area may run off the edge of the image area according to the second exemplary embodiment. In this case, the cropping area may be corrected to fit in the image area similar to the first exemplary embodiment.

According to another exemplary embodiment, the cropping area obtained in the first and the second exemplary embodiments are enlarged. For example, with respect to the user-designated minimum rectangle obtained in the first exemplary embodiment, a predetermined value is added to Xmax or Ymax or a predetermined value is subtracted from Xmin or Ymin to enlarge the user-designated minimum rectangle.

Then, printing points such as printing points 907 and 908 illustrated in FIG. 7 which are near sides of the user-designated minimum rectangle can be more reliably included in the cropping area. Further, a similar effect can be obtained by obtaining a cropping area and enlarging the cropping area while maintaining its aspect ratio.

Although the aforementioned exemplary embodiments describe a cropping method employed when printing digital image data recorded in a recording medium such as a CompactFlash®, the present invention is not limited to a cropping area creating method of digital image data recorded in a recording medium.

For example, in recent years, demand for a multifunction apparatus which can perform card direct printing and includes a scanner device is growing. An image scanned by the scanner device is converted into digital image data and printed by the apparatus. Even in a case of cropping digital data scanned by a scanner device in such an apparatus, the cropping area can be set similar to the above-described operation.

According to the above-described exemplary embodiments, the cropping area is designated according to an operation by the user using a touch panel provided on the printing apparatus. The present invention, however, is not limited to such a method and, for example, an operation unit such as a button can be used in the designation of the cropping area. Further, the cropping area can be designated through, for example, a mouse or a keyboard of a personal computer (PC). The aspect ratio of the printing area in this case can be obtained according to a print setting of the printer driver.

Further, a method used only for displaying a cropped image other than for printing is included in the present invention. For example, the method of the present invention is also applicable to a case where an image scanned by a scanner device, an image stored in a recording medium, or an image downloaded through the Internet is displayed on a display device using a PC. In addition, a method used for cropping an image taken by a digital camera and displaying the image on a display device such as a liquid crystal monitor of the camera or a television is also included in the present invention. In displaying a cropped image, the aspect ratio of the cropping area can be, for example, the same as the aspect ratio before cropping or can be an aspect ratio of a display area of the display device.

The present invention can be also achieved by supplying a recording medium for recording a program code which is configured to realize a function of the above-described exemplary embodiments, to a system or an apparatus and reading out and executing the program code stored in the recording medium by a computer (or CPU or MPU) of the system or the apparatus. In this case, the program code read out from the recording medium itself realizes the functions of the above-described exemplary embodiments and the program code and the recording medium which stores the program code also falls within the scope of the present invention. A recording medium for storing the program code includes, for example, a hard disk, a CD-ROM, a CD-R, a non-volatile memory card, a ROM, and a DVD.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions. This application claim s priority from Japanese Patent Application No. 2007-217382 filed Aug. 23, 2007, which is hereby incorporated by reference herein in its entirety.

What is claimed is:

1. A method for controlling a printing apparatus for printing an image on a recording sheet and including a display unit configured to display an image and a touch panel provided in a front face of the display unit, the method comprising:
displaying a display image on the display unit based on image data;
detecting a plurality of positions touched on the touch panel;
for each of the positions detected on the touch panel, designating a position on the display image displayed on the display unit according to the position detected on the touch panel;
obtaining an aspect ratio of a printing area;
determining a crop area of the display image having the aspect ratio of the printing area and including all of the designated positions on the display image; and
printing an image on a recording sheet based on the determined crop area.

2. The method according to claim 1, wherein the aspect ratio of the printing area is obtained based on a print setting.

3. The method according to claim 1, further comprising reading image data from a memory card and wherein the image displayed on the display unit is based on the image data read from the memory card.

4. The method according to claim 1, wherein the image data includes a thumbnail image and the thumbnail image is displayed on the display unit.

5. The method according to claim 1, further comprising:
receiving a rotate instruction;
determining whether the image can be rotated based on the determined crop area;
displaying a rotated image if it is determined that the display image can be rotated based on the determined crop area; and
displaying an indication that the display image can not be rotated if it is determined that the image can not be rotated based on the crop area.

6. A computer-readable recording medium in which a computer-executable program adapted to execute the method according to claim 1 is recorded.

7. A printing apparatus configured to print an image on a recording sheet, comprising:
a display unit configured to display the image;
a touch panel provided on a front face of the display unit;
a display control unit configured to display a display image on the display unit based on the image data;
a detection unit configured to detect a position touched on the touch panel;
a determination unit configured to determine an area on the display image based on a plurality of positions on the displayed image which are designated according to a plurality of respective positions detected by the detection unit, and an aspect ratio of a printing area; and
a print unit configured to print the image on the recording sheet based on image data corresponding to the area determined by the determination unit taken out from the image data.

8. A method for selecting an image from an area, comprising:
displaying a display image on a display device based on image data;
designating a position on the displayed display image according to an instruction from a user; and
determining an area on the display image based on the designated position on the display image, wherein the determined area includes a plurality of positions on the designated display image and has a predetermined aspect ratio.

9. The method according to claim 8, further comprising printing an image on a recording sheet based on image data corresponding to the determined area taken out from the image data, wherein the predetermined aspect ratio is an aspect ratio of a printing area of the image to be printed.

10. The method according to claim 8, further comprising enlarging the image in the determined area taken out from the image data and displaying the enlarged image on the display device, wherein the predetermined aspect ratio is an aspect ratio of the displayed image.

11. The method according to claim 8, further comprising determining an area in the display image, wherein an average of the plurality of positions designated on the display image is at a center of the area on the display image.

12. A computer-readable recording medium in which a computer-executable program adapted to execute the method according to claim 8 is recorded.
